(19) United States
(12) Patent Application Publication
(10) Pub. No.: US 2024/0391293 A1
(43) Pub. Date: Nov. 28, 2024

(54) AIR CONDITIONER FOR VEHICLE

(71) Applicant: Hanon Systems, Daejeon (KR)

(72) Inventors: Chan Joo MAENG, Daejeon (KR); Han Su KIM, Daejeon (KR); Tae Yeong PARK, Daejeon (KR); Gyu Ik HAN, Daejeon (KR); Heon HUR, Daejeon (KR)

(21) Appl. No.: 18/668,836

(22) Filed: May 20, 2024

(30) Foreign Application Priority Data
May 23, 2023 (KR) 10-2023-0066365

(51) Int. Cl. B60H 1/00

(52) U.S. Cl. CPC B60H 1/00521; B60H 1/00571

(57) ABSTRACT

The present invention may provide an air conditioner for a vehicle, which includes components of a compressor, a heat exchanger, and an expansion valve that are connected by pipes, including a bracket configured to fix the pipes to the components, wherein the bracket includes a body and a part extending from the body, a fastening part to which the component and pipe are fixed is formed on the part, and the fastening part includes a fastening member inserted into an assembly part of the pipe.

### CROSS-REFERENCE TO RELATED APPLICATION

This application claims priority to and the benefit of Korean Patent Application No. 10-2023-0066365, filed on May 23, 2023, the disclosure of which is incorporated herein by reference in its entirety.

### BACKGROUND

### Field of the Invention

The present invention relates to an air conditioner for a vehicle.

### Discussion of Related Art

Vehicles are provided with an air conditioner for controlling indoor air temperature and ventilation. In addition, the air conditioner for a vehicle keeps warm air inside the vehicle by generating the warm air in the winter and keeps cool air inside the vehicle by generating the cold air in the summer.

The air conditioner for a vehicle may include a compressor, a condenser, an expansion valve, an evaporator, and pipes connecting the compressor, the condenser, the expansion valve, and the evaporator through which a heat exchange medium, such as a refrigerant, circulates. Therefore, the compressor changes a refrigerant discharged after evaporated from the evaporator into a refrigerant in a high temperature and high pressure state and supplies the refrigerant to the condenser. In addition, the condenser performs a function of condensing (liquefying) the introduced high-temperature and high-pressure refrigerant. In addition, the expansion valve expands the condensed refrigerant, and the expanded refrigerant is supplied to the evaporator to exchange heat with air. In this case, the air heat-exchanged with the refrigerant in the evaporator may be supplied to the inside of the vehicle by a blower.

Meanwhile, the air conditioner for a vehicle may use a heat pump system to provide a cooling and heating system. The heat pump system may be provided with a gas-liquid separator for separating liquid refrigerant instead of an internal heat exchanger to increase a flow rate of the refrigerant for the compressor through vapor injection that additionally supplies the gaseous refrigerant pressure with liquid refrigerant separated to the compressor, thereby increasing the cryogenic heating capacity.

The pipe connected to the condenser may be fixed to the condenser through a separate bracket.

However, in the case of an air conditioner for a vehicle provided with a heat pump, due to a structure connected to a refrigerant switching valve, a connection structure and assembly direction of a bracket connected to the condenser are different from those of the bracket of the air conditioner for a vehicle to which the heat pump is not applied, and thus there is a problem that separate brackets having different shapes should be provided.

### RELATED ART DOCUMENT

### Patent Document

(Patent Document 1) Japanese Patent Application Laid-Open No. 2017-215053 (published on Dec. 7, 2017).

### SUMMARY OF THE INVENTION

The present invention is directed to providing an air conditioner for a vehicle capable of being applied to both an air conditioner for a vehicle to which a heat pump is applied and an air conditioner for a vehicle to which the heat pump is not applied.

The object of the present invention is not limited to the above-described object, and other objects that are not mentioned will be able to be clearly understood by those skilled in the art from the following description.

An air conditioner for a vehicle, which includes components of a compressor, a heat exchanger, and an expansion that are connected by pipes, includes a bracket configured to fix the pipe to the component, wherein the bracket includes a body and a part extending from the body, a fastening part to which the component and pipe are fixed is formed on the part, and the fastening part includes a fastening member inserted into an assembly part of the pipe.

The body may include a first body and a second body, the part may include a first part, a second part, and a third part, the first part may extend from one side of the first body, the second part may be bent and extend from the other side of the first body in a first direction, the second body may be bent and extend from the second part in a second direction differing from the first direction, the third part may be bent and extend from the second body in the first direction, and the third part may include a first fastening hole into which the fastening member is mounted at both sides of the third part with respect to a third direction differing from the first direction.

The first part may be coupled to a condenser.

The second part may be coupled to a first pipe connected to a gas-liquid separator or the expansion valve.

A first pipe may be coupled to the second part from top to bottom with respect to the third direction.

The third part may be coupled to a second pipe that is a suction pipe.

The second pipe may be coupled to the third part from top to bottom with respect to the third direction.

The third part may be coupled to a third pipe connected to a refrigerant switching valve.

The third pipe may be coupled to the third part from bottom to top with respect to the third direction.

A fastening area of the fastening member may protrude upward from an upper surface of the second part with respect to the third direction.

A fastening area of the fastening member may protrude upward from an upper surface of the second part with respect to the third direction.

The second direction may be perpendicular to the first direction.

The first part may include a second fastening hole.

A direction of the first fastening hole may be perpendicular to a direction of the second fastening hole.

The fastening member may protrude upward or downward according to air-conditioning specifications.

When the pipe is coupled from top to bottom, the fastening member may protrude upward, and when the pipe is coupled from bottom to top, the fastening member may protrude downward.

An assembly part of the pipe may include a rotation prevention part formed to protrude from one surface of the assembly part, and the rotation prevention part may be in contact with the bracket to prevent rotation of the pipe about the fastening member.

### BRIEF DESCRIPTION OF THE DRAWINGS

FIG. 1 is a view showing an air conditioner for a vehicle according to an embodiment which is a condenser of an air conditioner for a vehicle to which a heat pump is not applied.

FIG. 2 is a view showing an air conditioner for a vehicle according to an embodiment which is a condenser of an air conditioner for a vehicle to which the heat pump is applied.

FIGS. 3 and 4 are views showing a state before a bracket applied to the air conditioner for a vehicle to which the heat pump is not applied is connected to a first pipe and a second pipe.

FIG. 5 is a view showing a state in which the first pipe and the second pipe are connected to the bracket for a vehicle shown in FIGS. 3 and 4.

FIGS. 6 and 7 are views showing a state before a bracket applied to the air conditioner for a vehicle to which the heat pump is applied is connected to the first pipe and the second pipe.

FIGS. 8 and 9 are views showing a state in which the first pipe and a third pipe are connected to the bracket shown in FIGS. 6 and 7.

### DETAILED DESCRIPTION OF EXEMPLARY EMBODIMENTS

Hereinafter, exemplary embodiments according to the present invention will be described in detail with reference to the accompanying drawings.

However, the technical spirit of the present invention is not limited to some of the described embodiments, but may be implemented in various different forms, and one or more of the components among the embodiments may be used by being selectively coupled or substituted without departing from the scope of the technical spirit of the present invention.

In addition, terms (including technical and scientific terms) used in embodiments of the present invention may be construed as meaning that may be generally understood by those skilled in the art to which the present invention pertains unless explicitly specifically defined and described, and the meanings of the commonly used terms, such as terms defined in a dictionary, may be construed in consideration of contextual meanings of related technologies.

In addition, the terms used in the embodiments of the present invention are for describing the embodiments and are not intended to limit the present invention.

In the specification, a singular form may include a plural form unless otherwise specified in the phrase, and when described as “at least one (or one or more) of A, B, and C,” one or more among all possible combinations of A, B, and C may be included.

In addition, terms such as first, second, A, B, (a), and (b) may be used to describe components of the embodiments of the present invention.

These terms are only for the purpose of distinguishing one component from another component, and the nature, sequence, order, or the like of the corresponding components is not limited by these terms.

In addition, when a first component is described as being “connected,” “coupled,” or “joined” to a second component, it may include a case in which the first component is directly connected, coupled, or joined to the second component, but also a case in which the first component is “connected,” “coupled,” or “joined” to the second component by other components present between the first component and the second component.

In addition, when the first component is described as being formed or disposed on “on (above) or below (under)” the second component, “on (above)” or “below (under)” may include not only a case in which two components are in direct contact with each other, but also a case in which one or more third components are formed or disposed between the two components. In addition, when described as “on (above) or below (under),” it may include the meaning of not only an upward direction but also a downward direction based on one component.

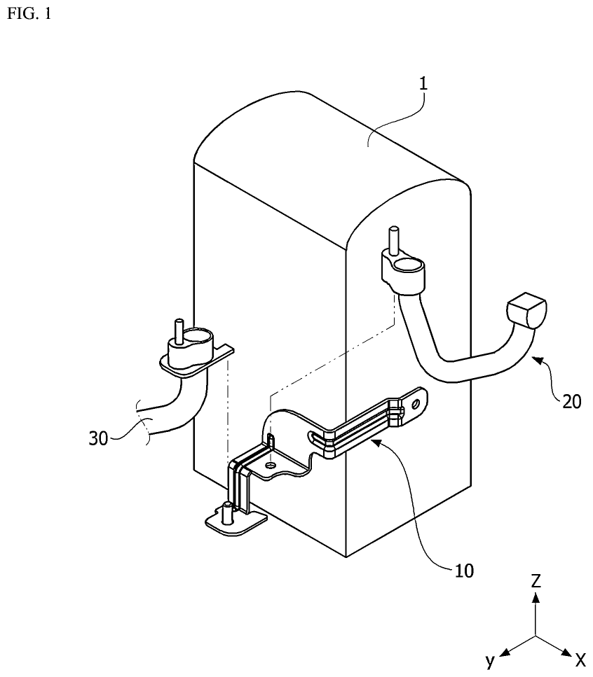

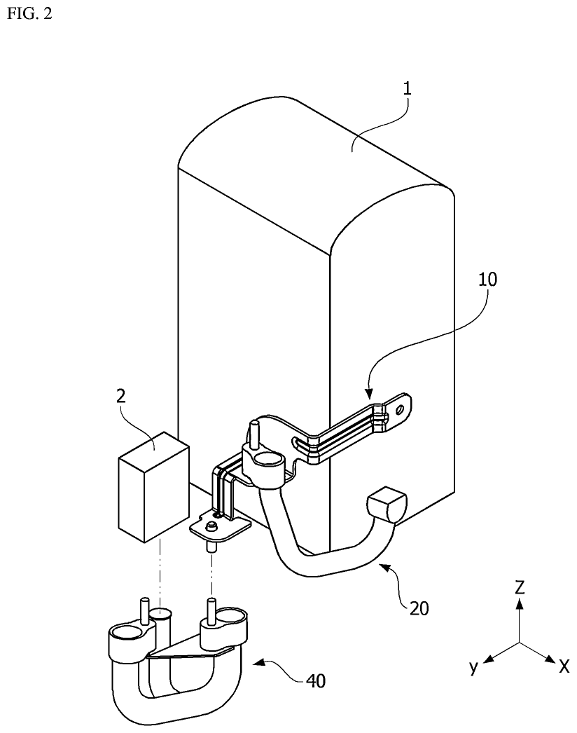

FIG. 1 is a view showing an air conditioner for a vehicle according to an embodiment which is a condenser of an air conditioner for a vehicle to which a heat pump is not applied, and FIG. 2 is a view showing an air conditioner for a vehicle according to an embodiment which is a condenser of an air conditioner for a vehicle to which the heat pump is applied.

Hereinafter, in the drawings, a Y-axis indicates a first direction, a Z-axis indicates a second direction, and an X-axis indicates a third direction. The first direction is perpendicular to the second direction, and the second direction is perpendicular to the third direction.

Each component of a compressor, a heat exchanger, and an expansion valve is connected by a pipe. A bracket 10 for a vehicle fixes pipes to components. In addition, the components correspond to parts that cause a change in phase, such as compression, condensation, expansion, and evaporation of refrigerant in a refrigerant system.

Referring to FIG. 1, one side of the bracket 10 applied to an air conditioner for a vehicle to which a heat pump is not applied is coupled to a condenser 1. In addition, a first pipe 20 and a second pipe 30 may be connected to the bracket 10. One end of the first pipe 20 is coupled to the bracket 10 and the other end is connected to the condenser 1. In addition, the first pipe 20 may be connected to the expansion valve. In addition, one end of the second pipe 30 may be coupled to the bracket 10. The second pipe 30 may be a suction pipe.

Referring to FIG. 2, the bracket 10 applied to the air conditioner for a vehicle to which the heat pump is not applied may also be applied to an air conditioner for a vehicle to which the heat pump is applied. One side of the bracket 10 is coupled to the condenser 1. In addition, the first pipe 20 and a third pipe 40 may be connected to the bracket 10. One end of the first pipe 20 is coupled to the bracket 10 and the other end is connected to the condenser 1. In addition, the first pipe 20 may be connected to a gas-liquid separator. In addition, one end of the second pipe 30 may be coupled to the bracket 10. The third pipe 40 may be a suction pipe connected to a refrigerant switching valve 2. In addition, the third pipe 40 may be connected to an air-cooled condenser or accumulator.

As described above, the bracket 10 is coupled to each of two pipes to support the two pipes in a state of being fixed to the condenser 1.

In this case, since the same bracket 10 is applied to both the air conditioner for a vehicle to which the heat pump is not applied and the air conditioner for a vehicle to which the heat pump is applied, it is possible to reduce the number of parts, thereby greatly increasing the productivity of the air conditioner for a vehicle.

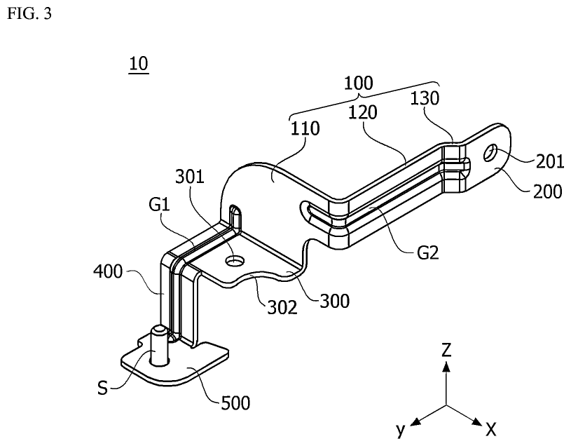

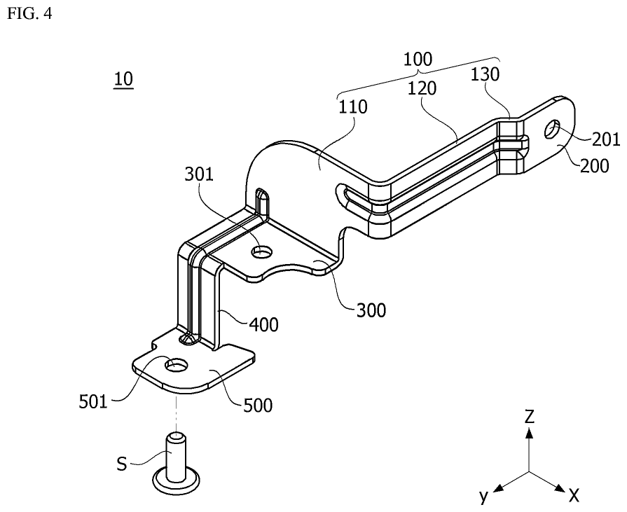

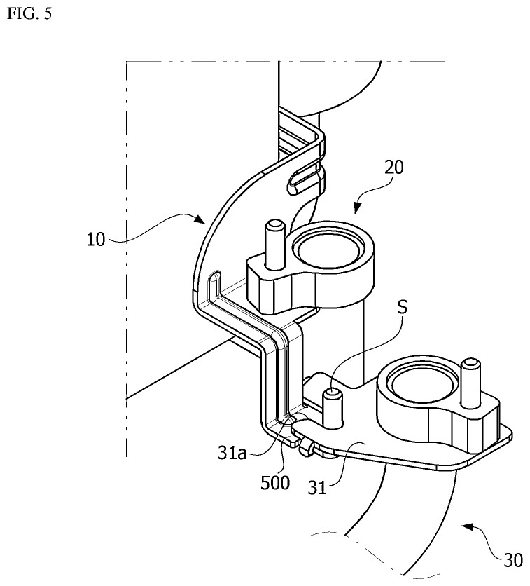

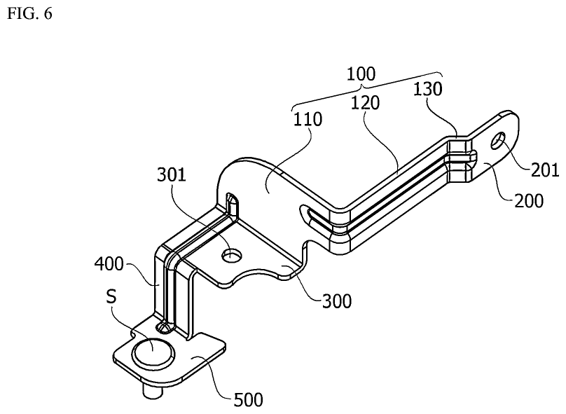

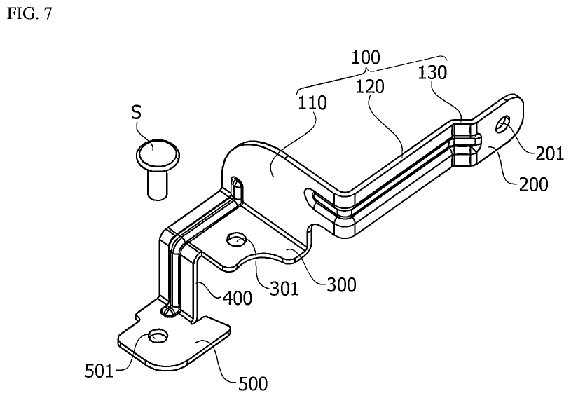

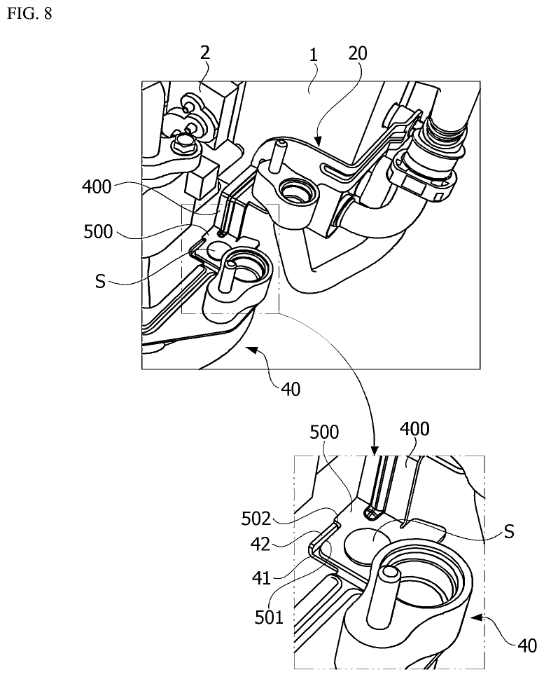

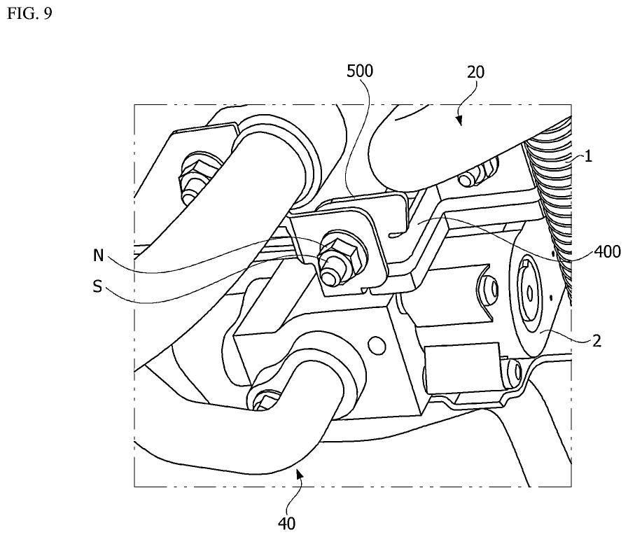

FIGS. 3 and 4 are views showing a state before a bracket 10 applied to the air conditioner for a vehicle to which the heat pump is not applied is connected to a first pipe 20 and a second pipe 30, FIG. 5 is a view showing a state in which the first pipe 20 and the second pipe 30 are connected to the bracket 10 for a vehicle shown in FIGS. 3 and 4, FIGS. 6 and 7 are views showing a state before a bracket applied to the air conditioner for a vehicle to which the heat pump is applied is connected to the first pipe and the second pipe, and FIGS. 8 and 9 are views showing a state in which the first pipe 20 and a third pipe 40 are connected to the bracket 10 shown in FIGS. 6 and 7.

Referring to FIGS. 3 to 9, the bracket 10 applied to the air conditioner for a vehicle to which the heat pump is not applied and the bracket 10 applied to the air conditioner for a vehicle to which the heat pump is applied may include a body and a part extending from the body. The body may include a first body 100 and a second body 400, and the part may include a first part 200, a second part 300, and a third part 500.

The first body 100 may be connected to each of the first part 200 and the second part 300. The first body 100 may include a 1-1 body 110, a 1-2 body 120, and a 1-3 body 130. The 1-1 body 110, the 1-2 body 120, and the 1-3 body 130 may each be a plate-shaped member. The first body 100 may be formed to include a plurality of bending areas. Bending directions of the plurality of bending areas of the first body 100 may be different.

Specifically, the 1-2 body 120 may be formed to be bent from the 1-1 body 110 in the first direction (Y-axis direction) using the Z-axis as a bending axis. The 1-3 body 130 may be formed to be bent from the 1-2 body 120 in the third direction (X-axis direction) using the Z-axis as the bending axis. The 1-3 body 130 may be connected to the first part 200.

The first part 200 may extend from one side of the 1-3 body 130 of the first body 100. The first part 200 may be a plate-shaped member. The first part 200 is an area coupled to the condenser 1. The first part 200 may include a second fastening hole 201. The second fastening hole 201 may be formed to pass through the first part 200 in the first direction (Y-axis direction). A fastening member may be inserted through the second fastening hole 201 and coupled to the condenser 1.

The second part 300 may extend from one side of the 1-1 body 110 of the first body 100 and may be formed to be bent in the first direction (Y-axis direction) using an X-axis as the bending axis. The second part 300 may be a plate-shaped member. The second part 300 is an area in which the first pipe 20 is coupled. Here, the first pipe 20 may be a pipe connected to a gas-liquid separator or an expansion valve.

An edge of the second part 300 may include a concave rounded area 302. The rounded area 302 is formed by considering a shape of the first pipe 20 to be coupled to the first pipe 20.

The second body 400 may be formed to be bent from the edge of the second part 300 in the second direction (Y-axis direction) using the X-axis as the bending axis. The second body 400 may also be a plate-shaped member.

The third part 500 may be formed to be bent from an edge of the second body 400 in the first direction (Y-axis direction) using the X-axis as the bending axis. The third part 500 may be a plate-shaped member. The third part 500 is an area in which the second pipe 30 or the third pipe 40 is connected of the air conditioner for a vehicle to which the heat pump is applied. Here, the second pipe 30 may be a suction pipe, and the third pipe 40 may be a pipe connected to the refrigerant switching valve 2.

The second part 300 and the third part 500 may be disposed in parallel. In addition, the second part 300 and the third part 500 may be disposed to be stepped with respect to the second direction (Z-axis direction). An area of the second part 300 may be greater than that of the third part 500.

The bracket 10 may include a first rib G1 and a second rib G2. The first rib G1 and the second rib G2 are used to increase the strength of the bracket 10 having a bent shape.

The first rib G1 may be disposed over the 1-1 body 110, the second part 300, the second body 400, and the third part 500. The first rib G1 may be formed in a concave shape in a surface of the bracket 10.

The second rib G2 may be disposed over the 1-1 body 110, the 1-2 body 120, the 1-3 body 130, and the first part 200. The second rib G2 may also be formed in a concave shape in the surface of the bracket 10.

In the bracket 10 applied to the air conditioner for a vehicle to which the heat pump is not applied, a fastening member S may be coupled from bottom to top in the drawing with respect to the second direction (Z-axis direction). A body of the fastening member S passes through a first fastening hole 501 and is located to protrude more than an upper surface of the third part 500. The second pipe 30 may be assembled from top to bottom to the fastening member S passing through the first fastening hole 501.

Specifically, the second pipe 30 may include an assembly part 31. The assembly part 31 may be disposed in contact with the third part 500. The assembly part 31 may include a slot 31a that is concavely formed at an edge thereof. In a process of coupling the second pipe 30 to the bracket 10, the fastening member S may be inserted into the slot 31a of the assembly part 31.

Meanwhile, in the bracket 10 applied to the air conditioner for a vehicle to which the heat pump is applied, the fastening member S may be coupled from top to bottom with respect to the second direction (Z-axis direction). The body of the fastening member S passes through the first fastening hole 501 and is located to protrude more than a lower surface of the third part 500. The third pipe 40 may be assembled from bottom to top to the fastening member S passing through the first fastening hole 501.

Specifically, the third pipe 40 may include an assembly part 41. The assembly part 41 may be disposed in contact with the third part 500. The assembly part 41 may include a hole passing through upper and lower surfaces of the assembly part 41.

Referring to FIG. 9, in the process of coupling the third pipe 40 to the bracket 10, the fastening member S is inserted into the hole of the assembly part 41. Since a nut N may be fastened to the exposed area of the fastening member S passing through the assembly part 41, the fastening member S may be fixed to a flange.

The assembly part 41 may include a rotation prevention part 42 protruding from one surface of the assembly part 41. In addition, the third part 500 may include a first surface S1 and a second surface S2 that form a groove in which the rotation prevention part 42 is located. The second surface S2 may be formed perpendicular to the first surface S1. The rotation prevention part 42 is caught on the first surface S1 or the second surface S2, thereby preventing the third pipe 40 from rotating about the fastening member S.

Meanwhile, although an example in which the body of the fastening member S passes through the first fastening hole 501 and is located to protrude more than the upper surface of the third part 500 or the body of the fastening member S passes through the first fastening hole 501 and is located to protrude more than the lower surface is described, the present invention is not limited thereto, and the bracket 10 may be formed in a type in which the fastening member S is formed integrally with the third part 500. In this case, the fastening member S may be disposed only on any one of the upper and lower surfaces of the third part 500. For example, the fastening member S may protrude upward from the upper surface of the third part 500. Alternatively, the fastening member S may protrude downward from the lower surface of the third part 500.

Alternatively, the fastening member S may be disposed on each of the upper and lower surfaces of the third part 500. For example, the fastening member S may protrude upward from the upper surface of the third part 500 and simultaneously protrude downward from the lower surface of the third part 500.

The size and shape of the bracket 10 applied to the air conditioner for a vehicle to which the heat pump is not applied are the same as those of the bracket 10 applied to the air conditioner for a vehicle to which the heat pump is applied. Depending on whether the heat pump is applied, only the assembly direction of the fastening member S mounted on the bracket 10 is set differently. Therefore, there is an advantage in that it is possible to increase productivity through the bracket commonly used between the air conditioner for a vehicle to which the heat pump is not applied and the air conditioner for a vehicle to which the heat pump is applied.

The air conditioner for a vehicle according to one exemplary embodiment of the present invention has been described above in detail with reference to the accompanying drawings.

According to embodiments, an air conditioner for a vehicle can be applied to both an air conditioner for a vehicle to which a heat pump is applied and an air conditioner for a vehicle to which the heat pump is not applied, thereby reducing the number of parts and increasing productivity.

The above-described embodiment of the present invention should be understood in all respects as illustrative and not restrictive, and the scope of the present invention will be determined by the claims to be described below rather than the above-described detailed description. In addition, not only the meanings and scopes of the claims but also all changeable or modifiable forms derived from the equivalent concept thereof should be construed as being included in the scope of the present invention.

What is claimed is:

1. An air conditioner for a vehicle, which includes components of a compressor, a heat exchanger, and an expansion valve that are connected by pipes, the air conditioner comprising a bracket configured to fix the pipes to the components,
wherein the bracket includes a body and a part extending from the body,
a fastening part to which the component and pipe are fixed is formed on the part, and
the fastening part includes a fastening member inserted into an assembly part of the pipe.

2. The air conditioner of claim 1, wherein the body includes a first body and a second body,
the part includes a first part, a second part, and a third part,
the first part extends from one side of the first body,
the second part is bent and extends from the other side of the first body in a first direction,
the second body is bent and extends from the second part in a second direction differing from the first direction,
the third part is bent and extends from the second body in the first direction, and
the third part includes a first fastening hole into which the fastening member is mounted at both sides of the third part with respect to a third direction differing from the first direction.

3. The air conditioner of claim 1, wherein the first part is coupled to a condenser.

4. The air conditioner of claim 1, wherein the second part is coupled to a first pipe connected to a gas-liquid separator or the expansion valve.

5. The air conditioner of claim 1, wherein a first pipe is coupled to the second part from top to bottom with respect to the third direction.

6. The air conditioner of claim 1, wherein the third part is coupled to a second pipe that is a suction pipe.

7. The air conditioner of claim 6, wherein the second pipe is coupled to the third part from top to bottom with respect to the third direction.

8. The air conditioner of claim 1, wherein the third part is coupled to a third pipe connected to a refrigerant switching valve.

9. The air conditioner of claim 8, wherein the third pipe is coupled to the third part from bottom to top with respect to the third direction.

10. The air conditioner of claim 1, wherein a fastening area of the fastening member protrudes upward from an upper surface of the second part with respect to the third direction.

11. The air conditioner of claim 1, wherein a fastening area of the fastening member protrudes upward from an upper surface of the second part with respect to the third direction.

12. The air conditioner of claim 1, wherein the second direction is perpendicular to the first direction.

13. The air conditioner of claim 1, wherein the first part includes a second fastening hole.

14. The air conditioner of claim 12, wherein a direction of the first fastening hole is perpendicular to a direction of the second fastening hole.

15. The air conditioner of claim 1, wherein the fastening member protrudes upward or downward according to air-conditioning specifications.

16. The air conditioner of claim 1, wherein, when the pipe is coupled from top to bottom, the fastening member protrudes upward, and
when the pipe is coupled from bottom to top, the fastening member protrudes downward.

17. The air conditioner of claim 1, wherein the assembly part of the pipe includes a rotation prevention part formed to protrude from one surface of the assembly part, and
the rotation prevention part is in contact with the bracket to prevent rotation of the pipe about the fastening member.
